(19) United States
(12) Patent Application Publication
(10) Pub. No.: US 2007/0256362 A1
(43) Pub. Date: Nov. 8, 2007

(54) Assembly and method for automated operation of a restroom door

(76) Inventor: Curtis David Hansen, Victoria, MN (US)

Correspondence Address: DARDI & ASSOCIATES, PLLC, 220 S. 6TH ST., SUITE 2000, U.S. BANK PLAZA, MINNEAPOLIS, MN, 55402, US

(21) Appl. No.: 11/714,347

(22) Filed: Mar. 5, 2007

Related U.S. Application Data
(60) Provisional application No. 60/779,098, filed on Mar. 4, 2006.

(51) Int. Cl. E05F 15/10

(52) U.S. Cl. 49/32

(57) ABSTRACT

Some embodiments are directed to an automated exit apparatus for a lockable privacy restroom comprising: a door operator, an electronically activatable motorized strike system, and a door actuator operable without physical contact by a user's hand that is mounted on an interior of a privacy restroom. The actuator may be user-actuatable to unlock the door by electronically activating the motor for the strike and to open the door by electronically activating the operator.

### CROSS-REFERENCE TO RELATED APPLICATIONS

This application claims priority to U.S. Patent Application Ser. No. 60/779,098, filed Mar. 4, 2006, which is hereby incorporated by reference herein.

### FIELD OF THE INVENTION

The field of the invention relates in general to an automated exit apparatus for hands free operation of a restroom door in a locked privacy restroom.

### BACKGROUND OF THE INVENTION

Restrooms play a vital role in the design and function of every building structure. The image of an organizational entity or governmental agency, its future, and the morale of building occupants often centers on the condition of the facility's restrooms. Nothing gets more attention or complaints than a restroom having conditions of dirt and filth. Even apparently clean restrooms, however, may be unsanitary.

### INTRODUCTION TO THE INVENTION AND SUMMARY OF PREFERRED EMBODIMENTS

A restroom obviously appearing clean on the surface may rise to a level of a serious health and safety issue, particularly on a microscopic scale. Pathogenic microorganisms may be microscopically present which can be transmitted from person to person via direct contact with a surface-laden contaminant, such as blood or other bodily fluids left by a previous visitor of a restroom. Besides being a health issue directed to a restroom visitor, this condition may be of further concern to those whom are responsible for cleaning and maintaining the restroom given their prolong exposure to microbial contaminants.

In recent years, the Centers for Disease Control (CDC) has reported that hands and their contact with restroom surfaces are the most common way restroom germs are spread from person to person. An illness can occur by simply passing on a very minuscule amount of a restroom germ, such as Hepatitis A, Norwalk-like viruses, Giardia, or Shigella. The CDC further reports that over one-third or 33% of the population fail to wash their hands after using and leaving a restroom. At the heart of this health debate is the question of how the transmission of restroom germs can be limited or stopped to mitigate any occurrence of illness. The most obvious or common approach taken in the art is to wash hands thoroughly and frequently, especially after using the restroom. Even after washing, though, residual amounts of germs can be left on a person's skin that can be further transmitted to the handle of the restroom door and places beyond the restroom boundaries. There is a general consensus among microbiologists and other notable scientists and health care officials that faucet handles, restroom door handles and related surfaces in public restrooms are often contaminated with bacteria, notwithstanding reasonable efforts to clean each of their surfaces of germs with a disinfectant or similar substance from time to time.

A protective measure commonly directed in mitigating the transmission of germs, as occasionally advocated by the Federal Drug Administration (FDA), includes the use of a physical barrier of some sort, such as a single-use, disposable glove. However, this type of barrier may be an acceptable form of protection for food handling services and the like, but unacceptable in many respects for those individuals who frequent or use a public or private restroom in an office-related, commercial, or retail environment. Similarly, a paper towel may equally serve in the capacity of a temporary barrier to the likes of a glove during opportune moments of turning the water faucet on and off and opening the restroom door. However, the effectiveness of using any physical barrier of the type enumerated above depends on its availability within the restroom, which is not always the case for public or private restrooms.

The art does offer numerous means for automated operation of a door, particularly those directed to satisfying the requirements of the Americans with Disabilities Act (ADA), which may possibly serve in the capacity of reducing the transmission of germs by eliminating the need to engage a door handle upon exiting the restroom. The ADA primarily serves to make all places of public accommodation, including schools, government offices, retail establishments, and physician offices, accessible to all individuals with physical disabilities. Requirements for automated operation of a door in public places are set forth in the ADA. Door operators generally adhering to the ADA must address a variety of operative issues, including a temporal component for closing and opening the door, angular extent of the door's position at a fully open state, forces applied to stall operation of the door closure mechanism upon sensing an obstruction, extent of stored kinetic energy required to set in motion the return swing of the door for closure, and opening forces for manual operation of the door in the event of power failure, generally being set at not more than 15 lbf (67 N). Although an ADA-compliant door operator may suffice in the capacity to open any door, most if not all door operators in this category are directed to operate within specified guidelines to ensure “barrier-free” access to those with a physical disability, particularly enabling one with a disability to enter and leave a room freely without manual operation of the door.

Moreover, conventional automated exit systems are not suited for use with privacy restrooms. Privacy restrooms can be locked from the inside. But automated door-opening systems conventionally allow access from the outside so that the restroom can not be locked. And automated exit systems conventionally can not unlock a door. Thus conventional automated door systems can not be converted to a hands-free system by combining them with a hands-free button to activate them.

ADA-compliant doors are typically configured to provide automated means for entry and exit, they are inherently inadequate to serve in the capacity where privacy is paramount to the restroom visitor. Privacy in this instance is preferably maintained or controlled by the restroom visitor whereby automated entry is not desired and the door can be interiorly secured with a push-button, activated lock or equivalent to prevent unintentional or unauthorized entry by another during present use of the restroom. In other respects, ADA-compliant doors in general are configured to operate at or near the ADA guideline of 15 lbf for manual operation, which makes their use limited where minimal force, manual entry into a room is preferably desired, such in the instance of a private restroom.

Accordingly, there remains a need for an adequate, simplistic measure that maintains a level of privacy beyond that of an ADA-compliant door typically configured for two-way operation, operates with a minimal amount of applied force to commence opening of a door, and functions in conjunction with other automated devices commonly available in the art, such as water faucets made active and operable by a motion sensor of some sort, collectively of which may serve to assist in guarding against or minimizing a person's exposure to germs and other communicable substances while visiting and leaving a restroom.

In order to overcome the drawbacks notably observed in the prior art, an assembly contemplating a method for automated operation of a door has been devised for restrooms which permits a restroom visitor to exit the restroom without having to manually touch any portion of the door or its supporting structure, such as hand controlled actuators or switches positioned about a doorjamb or framing members.

Some embodiments thus provide an assembly for automated operation of a restroom door which diminishes a person's opportunity of contracting an illness by mitigating exposure to germs possibly existing on a restroom door handle.

Some embodiments thus provide an assembly for automated operation of a restroom door which complies with all applicable provisions of the Americans with Disabilities Act (ADA), specifically of which are directed to operation of a door operator in public places.

Some embodiments thus provide an assembly for automated operation of a restroom door which functions to the likes of a common, non-automated door and yet operates well below the 15 lbs opening force threshold generally mandated by the ADA for manual operation of doors equipped with a door operator.

Some embodiments thus provide an assembly for automated operation of a restroom door which can be easily installed in the header of either existing or newly constructed doorway structures.

Some embodiments thus provide an assembly for automated operation of a restroom door which is fully adjustable onsite in order to adhere to the requirements of the ADA and readily accessible for maintenance and replacement, principally by means of modular construction.

Some embodiments thus provide an assembly for automated operation of a restroom door which accomplishes the foregoing and other objects and advantages and which is economical, durable, and fully effective in performing its intended functions without unduly compromising the structural integrity of doorways commonly present in residential and commercial buildings.

Some embodiments thus include an assembly for use in a method for automated operation of a door has been devised for restrooms, the assembly comprising a door operator mounted within an upper portion or header of a doorway and having a door swing arm extending therefrom with the opposite end thereof being slidably attached to a track positioned at a top portion of a door, an actuator in the form of a pressure sensitive mat connectively coupled to an electronic control module (ECM) incorporated into and made part of the door operator and being interiorly situated within the restroom, on a floor surface, to permit a restroom visitor situated thereupon to activate a motor of the door operator and commence the door opening cycle, and an electronic strike assembly connectively coupled to ECM and mounted within a doorjamb of the doorway for releasing an outwardly extending plunger of a non-keyed, privacy lock in a prescribed manner as selectively established by programmable inputs at ECM.

Some embodiments include an automated exit apparatus for a lockable privacy restroom comprising: a door operator, an electronically activatable motorized strike system, and a door actuator operable without physical contact by a user's hand that is mounted on an interior of a privacy restroom, the actuator being user-actuatable to unlock the door by electronically activating the motor for the strike and to open the door by electronically activating the low-energy operator. Similarly, embodiments include a method of automating a privacy restroom, the method comprising placing an actuator operable without physical contact by a user's hand in an interior of the privacy restroom that is actuatable to unlock and open the restroom door. The apparatus and method may have the door actuator located on or near a floor of the restroom for user activation by pressing with a foot on the door actuator. Or the door actuator may be a touchless sensor. The door operator may be a low-energy operator. The low-energy operator may include a motor that engages a swing arm to open the door, and further have a clutch disposed between the motor and the swing arm that is disengaged unless the actuator is actuated such that the door can be opened manually by the user without engaging the motor. The door may be manually operable for entry and for exit within ADA guidelines. The automated exit apparatus would typically automate exit but not entry of the restroom.

### BRIEF DESCRIPTION OF THE SEVERAL VIEWS OF THE DRAWINGS

A preferred embodiment of the apparatus will now be described by way of example with reference to the accompanying drawings, in which:

FIG. 1 is a front view of a door operator comprising a motor fitted to a drive housing collectively positioned within and stored in a case;

FIG. 2 is a front perspective view of the door operator of FIG. 1 mounted within an upper portion or header of a doorway, an actuator situated interiorly within and on a floor surface of a restroom, and a door positioned within the doorway;

FIG. 3 is a top plan view of an actuator in the form of a pressure sensitive mat;

FIG. 4 is a top plan view of a door operator connected to a door positioned within a door sweep area;

FIG. 5 is a block diagram of an electronic control module (ECM) connectively coupled to a power source, obstruction detection circuit, a microprocessor, memory modules, switch input interface coupled to external switches, a motor and brake mechanism, and peripheral devices, including an actuator and an electronic strike assembly;

FIG. 6 is a top plan view of a door operator comprising a motor fitted with a drive housing collectively positioned within and stored in a case;

FIG. 7 is a partial cross sectional view taken along line 7-7 in FIG. 6 illustrating a drive transmission coupled to and situated in between a piston drive assembly and a motor;

FIG. 8 is a partial cross sectional view taken along line 8-8 in FIG. 1 illustrating a drive transmission coupled to and situated in between a piston drive assembly and a motor;

FIG. 9 is a partial side view of a motor and a drive shaft collectively coupled to a clutch drive mechanism;

FIG. 10 is a side view of a piston drive assembly;

FIG. 11 is a side view of first and second spring backing plates;

FIG. 12 is a cross sectional view taken along line 12-12 in FIG. 11 illustrating primary and secondary cylindrical members of a spring backing plate and placement of an o-ring about an outer cylindrical surface;

FIG. 13 is a cross sectional view o taken along line 13-13 in FIG. 11 illustrating diametrically opposed pressure relief ports extending through a primary cylindrical member of a second spring backing plate and an aperture extending centrally through first and second spring backing plates;

FIG. 14 is a side view of a piston plunger;

FIG. 15 is a cross sectional view taken along line 15-15 in FIG. 14 illustrating an annular wall member of a piston plunger;

FIG. 16 is a cross sectional view taken along line 16-16 in FIG. 14 illustrating a tensioner incorporated into a piston plunger;

FIG. 17 is a perspective view of an electronic strike assembly; and

FIGS. 18-20 are flow charts illustrating operation of a door operator to commence and complete a door operating cycle.

### DETAILED DESCRIPTION OF A PREFERRED EMBODIMENT

This application includes descriptions of automated hands-free door apparatuses that can open a restroom door from the inside that is locked from the inside. These apparatuses provide convenience and sanitation. Conventional automated door systems can not open and unlock a door from inside a restroom on a hands-free basis.

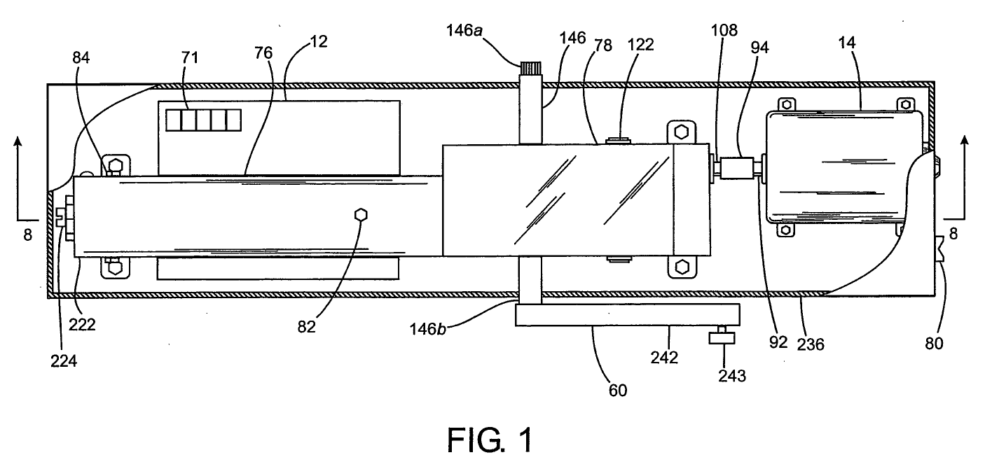

Reference is now made to FIG. 1 of the drawings illustrating an electromechanical door operator 10 of the type commonly known and readily available in the art for automated operation of a door, generally being directed for use in applications to meet accessibility requirements of the ADA. This embodiments has a door operator with an electronic control module (ECM) 12 having means for connecting and controlling a motor 14 and peripheral devices, such as an actuator or switch 16 to commence operation of the door operator and an electronic strike assembly 18 for activating and deactivating a door's lock mechanism 20, and means for reducing the output torque of the motor for compatible interaction with means for biasing a spring 22 to establish the requisite potential energy to enable door closing operability without continued activation and operation of the motor. Door operators generally comprising the above-noted features are, e.g., those types categorically included within the LCN 4630/4640 series manufactured by LCN, a division of Ingersoll Rand Company of Hamilton HM 11, Bermuda. With respect to door operators, also see, e.g., U.S. Pat. Nos. 4,040,144, 5,488,896, 5,513,467, 5,5507,120, 6,345,412, which are hereby incorporated by reference herein.

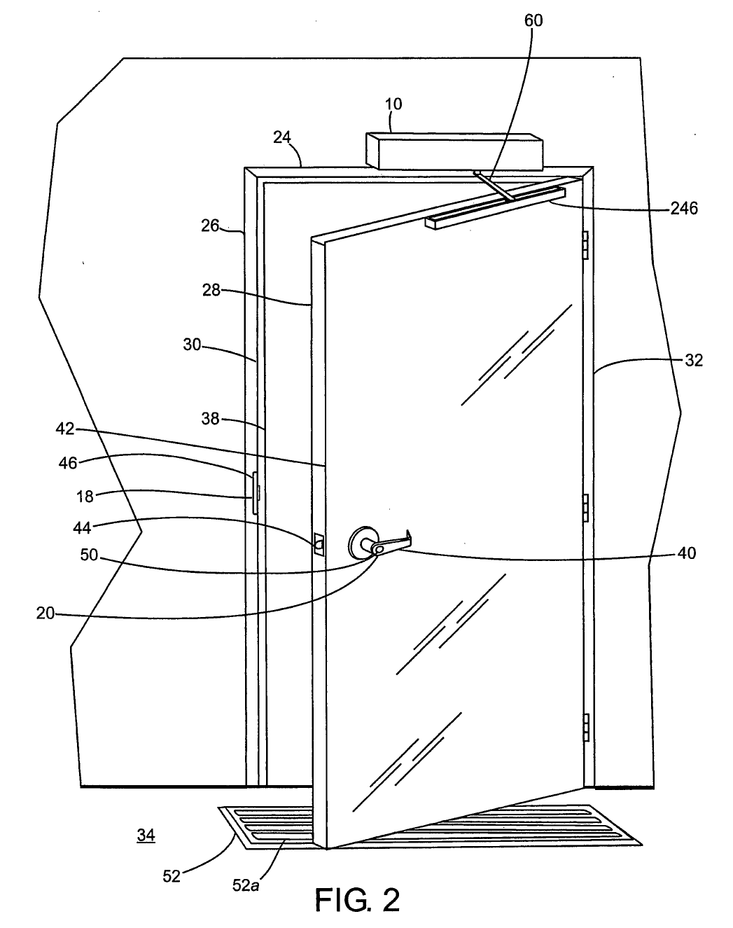

As illustrated in FIG. 2, the door operator is preferably mounted within an upper portion or header 24 of a doorway 26. A door 28, selectively positioned within the doorway, is swing mounted to a doorjamb 30 for opening about a hinge axis 32 or pivot axis extending vertically from a floor's surface 34 to the header, along a right edge portion 36 of the doorway, for example. A doorstop 38 integrally included as part of the doorjamb extends interiorly into and along the periphery of the doorway to serve as means for stopping the extent of door travel upon closure and ensuring proper alignment of the door with the doorjamb for securing it therewith. A door handle 40 is mounted to the door opposite the hinge axis, near a left leading edge 42 of the door. In the preferred embodiment, the door handle is of the type known in the art as a non-keyed, privacy lock generally comprising an outwardly extending plunger 44 for engaging a strike plate 46 and fitting interiorly within a plunger receptacle 48 of the electronic strike assembly made mountable within the doorjamb 30 and a push-button locking mechanism 50 that can be selectively engaged to lock the door 28 interiorly from within a restroom to further one's privacy while using the restroom and the like and disengaged in a timely manner by means of the electronic strike assembly communicatively coupled to ECM. This configuration suitably leaves the restroom in an unlocked condition upon one exiting the restroom, thus making it readily available for use by others. One such door handle 40 readily available in the art, generally comprising the above-noted operative features, is the AL-Series manufactured by the Schlage Company of Colorado Springs, Colo., specifically being directed for standard duty commercial applications.

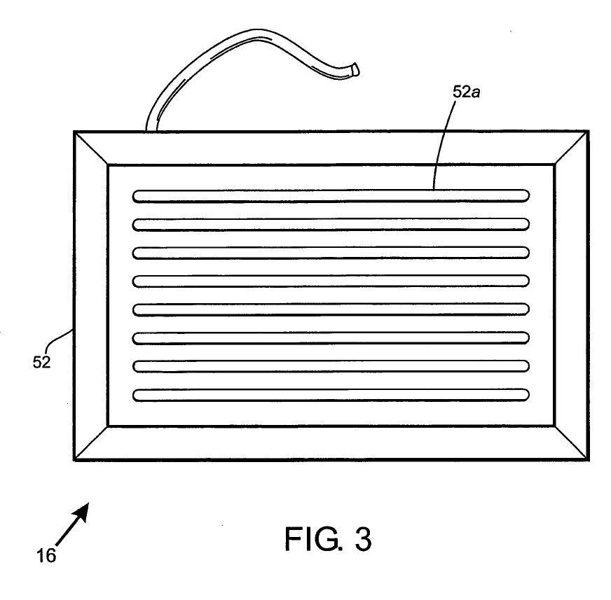

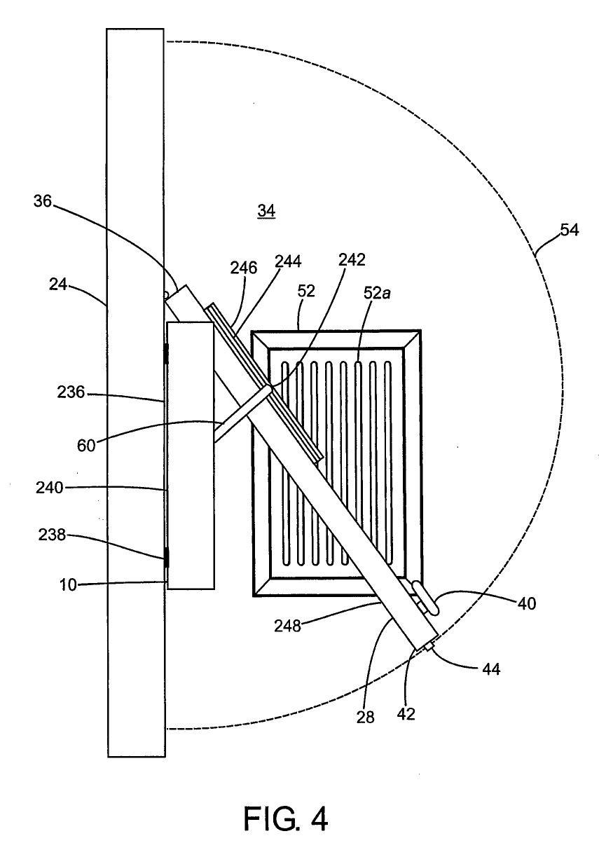

The actuator 14, as illustrated in FIG. 3, may exist in the form of a pressure sensitive mat 52 that is interiorly placed within the restroom, primarily existing within a door sweep area 54 as principally established by the pattern of door movement during opening and closing cycles, as shown in FIG. 4, and is communicatively coupled to ECM 12 to commence operation of the door operator 10. The actuator in this application is preferably of the type providing for activation by pressure sensitive means, primarily having a nominal sensitivity rating of at least 3-5 lbs, which can be generally expected by normal foot traffic near and at the door's sweep area.

An alternative embodiment of the actuator is a smaller mat. Such an actuator may be conveniently positioned at or near the floor so that a user may optionally use the mat or alternatively exit the restroom without using it. In some embodiments, such a mat has a surface area from about 2 to about 20° square inches; artisans will immediately appreciate that all the ranges and values within the explicitly stated ranges are contemplated, e.g., about 4° square inches or about 5 to about 5° square inches. One embodiment is a mat with a surface area of about 4° square inches having an 8 inch side and a 5 inch side, with a height of about 1.25 inches. The top edges of the mat may be beveled. Applicant has found that the smaller sizes can advantageously be installed quickly and with a minimum of retrofitting or alteration of the restroom's layout.

A variety of other hands-free actuating or switching devices commonly available in the art may be suited for use in this application other than the one directed for the preferred embodiment, providing each operates without the necessity of hand engagement. Hands-free is a term that means placed for actuation by a hand without requiring physical contact by a hand. While it is appreciated that a button on a floor can be pushed by a hand, such a button is not placed for actuation by a hand. In some embodiments, an actuator is placed on a floor or within no more than 24 inches from a floor; artisans will immediately appreciate that all the ranges and values within the explicitly stated ranges are contemplated, e.g., within 12 inches or 3 inches of a floor. Such actuators are not placed for hand-activation. Moreover, such actuators may be foot-actuatable, meaning that they respond to forces generated by a foot pressing on the actuator. Moreover, the apparatuses described herein may be combined with touchless actuators, such as proximity detectors and photoelectric cell-based detectors. Touchless refers to an actuator that requires no physical contact.

IActuator 14 in this instance becomes operative by means of supplying either 12 or 24 VDC power thereto, and once pressurely activated by foot traffic at or within the pressure sensitivity rating, a normally-open momentary contact switch inherently included as part of the actuator closes to complete the circuit and accordingly transmits an electric pulse to the ECM 12 to activate the door operator 10 to operate in accord with normal operating parameters selectively set therefor. The pressure sensitive mat may comprise a raised surface pattern 52a to enhance traction at and near the door sweep area 54. A pressure-sensitive mat 52 suitably serving in the capacity of an actuator for the preferred embodiment may include any one of the types manufactured by Larco Manufacturing of Brainerd, Minn.

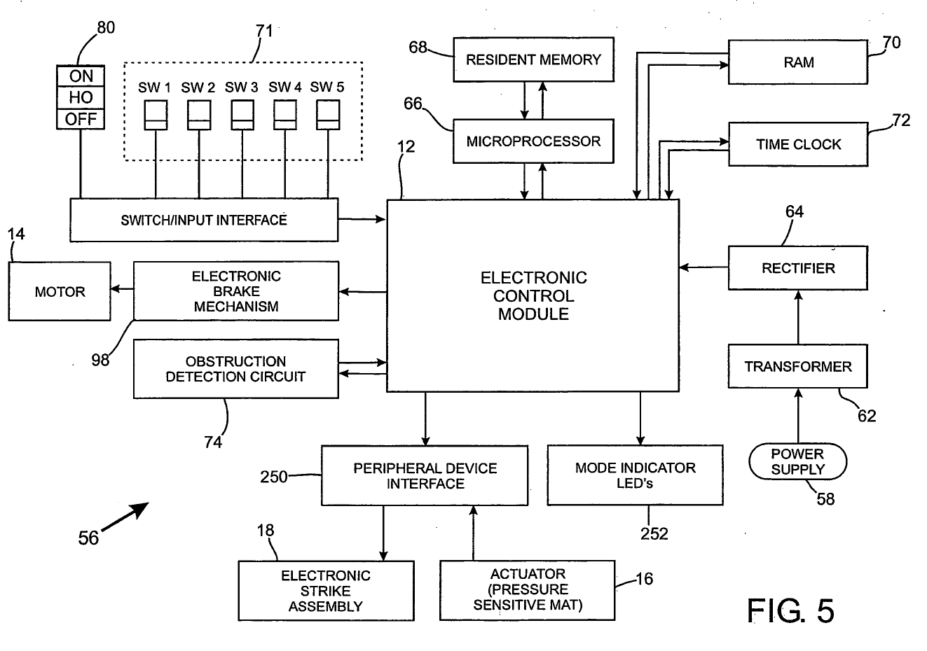

Referring now to FIG. 5, there is shown generally at 56 a block diagram which schematically illustrates the methodology and arrangement of the logic circuitry that contains ECM 12 for selectively controlling operation of the door operator 10, including the motor, and peripheral devices connectively coupled thereto, such as those components operably dedicated in activating the door operator and releasing the door lock under predetermined, timed constraints. As shown, 120 VAC from an outside power source 58 is transmitted to ECM 12 via means for converting the power from 120 VAC to 24 and 12 VDC, which serves as an output power source for powering peripheral devices coupled to ECM and the motor 14 that drives accordingly means for moving a door swing arm 60 in a prescribed manner for opening the door 28. In the preferred embodiment, converting means comprises a transformer 62 of the type capable of stepping down the incoming 120 VAC power to 12 and 24 VAC and a rectifier 64 of the type capable of converting the 12 and 24 VAC power to 12 and 24 VDC. Further coupled to ECM 12 is a microprocessor 66 that executes control operations according to a programmable instruction set, a resident memory module 68 for storing the instruction set, and a random access memory (RAM) module 70 suitably serving as system memory for temporary storage of input and output data accumulated during operation of the door operator. Microprocessors most suited for this application may include a variety of the types manufactured by Motorola Corporation of Schaumberg, Ill., Intel Corporation of Santa Clara, Calif., and Dallas Semiconductor of Dallas, Tex. IMicroprocessors 66 suited for this application may be adaptably configured to cooperate and function with polling or interrupting tasking commonly associated with the operation of microprocessors and the like to monitor in real time input and output devices communicatively coupled to the microprocessor via ECM 12, specifically to interrupt the microprocessor and accept and execute their noteworthy functionality during operation of the door operator 10. Although not shown herein in descriptive detail, it is understood in the art that the microprocessor may be accessible via a communication/data bus coupled in between ECM and the microprocessor to ensure unhindered data flows and timely access to memory to permit execution of the commands in the instruction set that are primarily directed to activate the peripheral devices (e.g., electronic strike, actuators, etc.) and motor 14 illustrated in FIG. 5. Resident memory modules most suited for this application may comprise of RAM, read only memory (ROM), or any combination thereof. Further, alternative forms of memory may be connectively coupled to ECM 12 to serve or supplement operation of the microprocessor, including, for example, an erasable programmable read only memory (EPROM), an electrically erasable programmable read only memory (EEPROM), a one time programmable read only memory (OTP ROM), a static random access memory (SRAM), FLASH or an equivalent form of memory appreciably known in the art. Although not described in detail herein, the instruction set may comprise a variety of commands capable of accepting data inputs and appropriately executing the stored values set by the operator for operation of the door operator 10 in a predetermined manner, such as those values accepted into memory by external switches 71 selectively directed to control timed delays for electronic strike activation, door travel speed during opening and closing cycles, duration the door 28 is held in an open state before activating the closing cycle, and extent of force for sensing obstructions in the door sweep area 54 to renew the opening cycle and for manual operation of the door, preferably being operable at or near an opening force of at least five pounds. Features of external switches and controls for operation of the door operator in a preferred manner will be provided hereinafter in more descriptive detail. Regardless of the program's command structure and layout, those having ordinary skill in the art recognize that the instruction set may be written in any suitable high level computer language, such as, for example, C or C++, and compiled into a suitable form for storage in the resident memory module 68 for later execution by the microprocessor 66. Alternatively, the instruction set may be written in assembly or machine language form and compiled into a suitable form for storage in the resident memory module. As illustrated in FIG. 5, ECM 12 may be further operatively connected to means for measuring time such as a real time clock or timer 72 which can be set, reset and read by the microprocessor to measure the passage of time. This real time clock is advantageous in executing timed sequenced events for door operation if selectively desired. A suitable real time clock for the door operator may be a 2K non-volatile “Dallas Timekeeper” RAM produced by Dallas Semiconductor of Dallas, Tex. Further coupled to ECM is an obstruction detection circuit 74 for deactivating the motor 14 upon sensing or detecting the presence of obstructions positioned within the door sweep area 54 during cyclic operation of the door operator 10. The obstruction detection circuit is adjustable at ECM 12 to set accordingly the stopping force required to deactivate the motor during the opening or closing cycle. If for instance an obstruction is detected during the closing cycle of the door operator, the motor is de-energized by ECM 12 and after a momentary delay is re-energized to renew the opening cycle notwithstanding the elapse of the hold open time of the door operator. Conversely, if an obstruction is detected during the opening cycle, the motor is de-energized with the door being allowed to close under the force of potential energy stored in the spring 22, as predominately contained within a posterior portion 76 of a drive housing 78. Also shown in FIG. 5, ECM is connectively coupled to a three position selector mode switch 80 that permits the door operator to be switched “ON” to monitor for and execute function inputs, switched to “HO” for indefinite hold open function, or switched “OFF” to disable all function inputs to permit the door operator 10 to be used exclusively as a manual door closer. Apart from the switching capabilities at ECM, the door operator 10 comprises first and second sets of adjustable hydraulic backcheck valves 82, 84 for mechanically controlling the force and speed of door operation, primarily to cushion the door speed if the door is opened in a violent or rapid manner and to control the speed for which the door closes and latches.

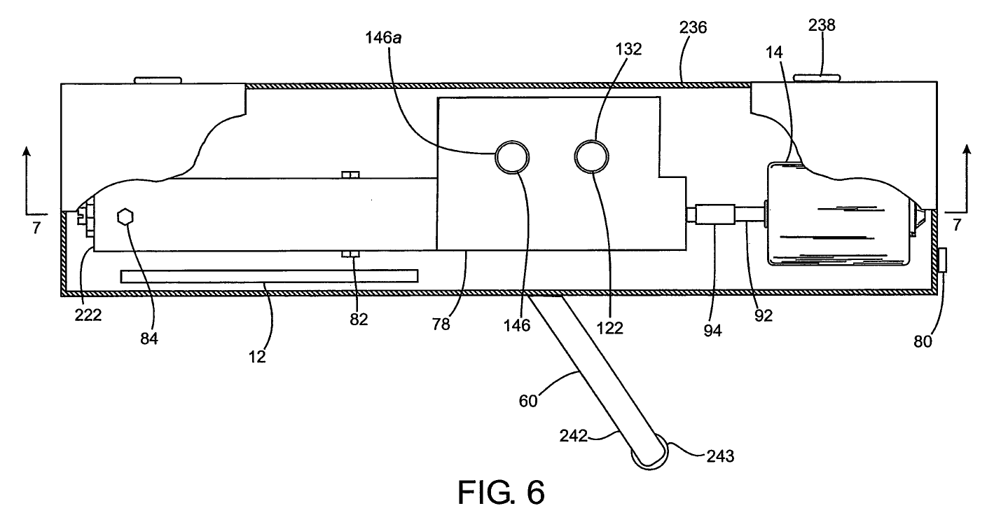

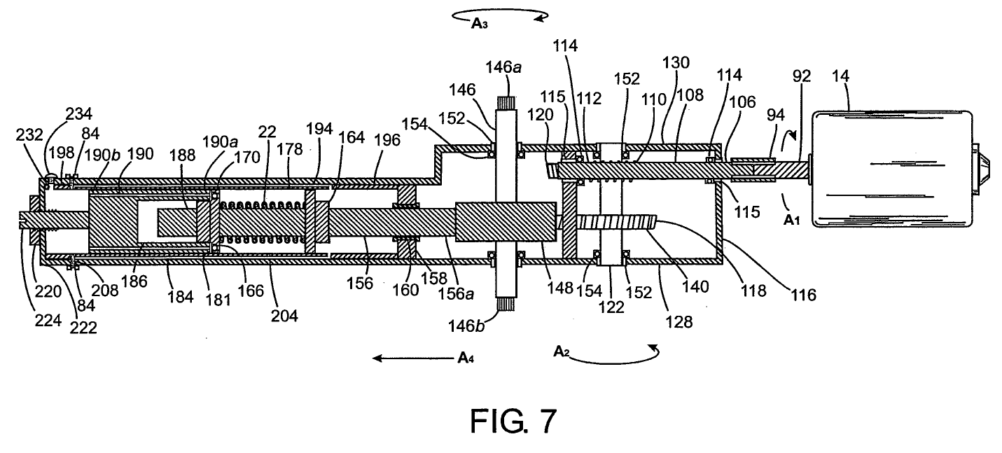

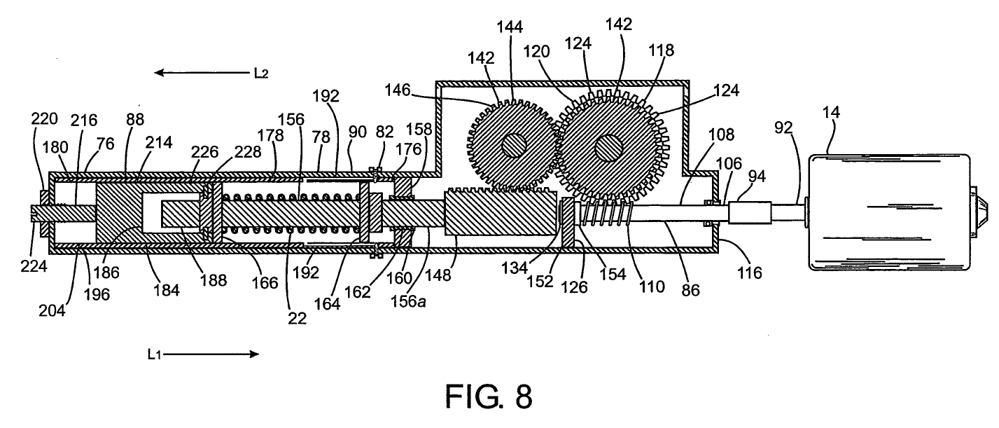

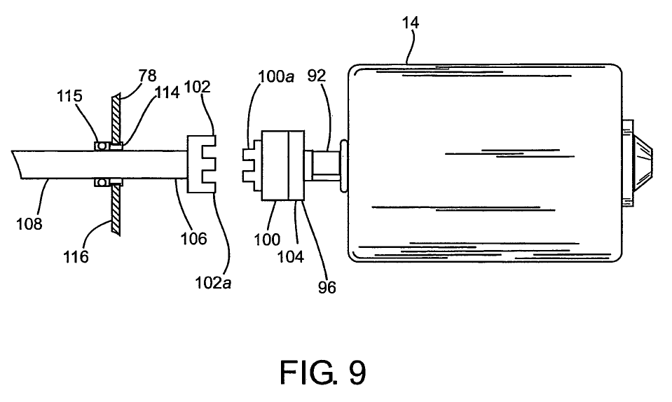

As c in FIGS. 1 and 6, the electromechanical door operator 10 comprises a drive transmission 86 for reducing the output torque of the motor for compatible interaction with a piston drive assembly 88 contained within a midsection portion 90 of the drive housing, which serves as means for biasing the spring 22 to establish the requisite potential energy for door closing operations. The drive transmission is preferably connected to an output shaft 92 of the motor by means of a coupling 94 or a clutch drive mechanism 96. The motor, which operates at preferred voltage of 110, inherently comprises an electronic braking mechanism 98 and associated circuitry coupled to ECM 12. The braking mechanism, which operates in accord with the pre-selected inputs at ECM, primarily actuates upon completing the door open cycle and remains in an actuated state until it times out by ECM, after which time the door closing cycle commences by means of deactivating the motor 14 and releasing the stored potential energy in the spring 22, as will be discussed in greater detail hereinbelow. As depicted in FIGS. 7 and 8, the output shaft 92 as well as the drive transmission is connectively fastened and keyed to the coupling 94 or to the clutch drive mechanism 96 to ensure little to no slippage during rotational operation. The clutch drive mechanism in particular comprises input and output mechanisms 100, 102 with each comprising a keyed face 100a, 102b that engage and lock with one another upon ECM 12 activating a solenoid motor 104 coupled to the input mechanism. As shown in FIG. 9, the input mechanism 100 and the solenoid motor are fixedly attached to the motor's output shaft 92 with the output mechanism being fixedly connected to a first end 106 of a drive shaft 108 of the drive transmission, and upon activation, the input mechanism moves laterally toward the output mechanism to engage and mesh therewith. The motor 14 cooperating with the clutch drive mechanism, if utilized, serves as means for minimizing damage to the door operator if in the event the door operator sustains abusive operation or a force is applied to the door operator that is greater than the tolerable force configured for opening and closing operations, as programmed at ECM 12. In other embodiments, the motor's output shaft and the drive shaft 108 of the drive transmission may be fixedly connected to one another through use of the coupling 94 to permit unison movement without disengagement and engaging operations as in the case for the clutch drive mechanism. The drive transmission 86 preferably comprises a pinion gear 110 positioned about a second end 112 of the drive shaft with the first end 106 thereof passing through a thrust bearing 114 and needle bearing 115 that exist within an anterior face portion 116 of the drive housing for connection to either the coupling or clutch drive mechanism 96 in such manner noted above. The pinion gear of the second end of the drive shaft 108 is arranged to interact with a first gear drive 118, specifically with a primary plate gear 120 that is mounted to a first vertical shaft 122 existing in vicinity of and extending perpendicular to the drive shaft. As depicted in FIG. 8, the pinion gear of the second end of the drive shaft is selectively orientated to mesh with a circumferential toothed portion 124 of the primary plate gear 120, which results in a configuration that permits the axis of rotational motion of the motor's output shaft 92 to be shifted 90 degrees along the longitudinal axis of the first vertical shaft. The second end 112 of the drive shaft is preferentially mounted and supported by a vertical brace 126 that extends upwardly from a bottom portion 128 of the drive housing and terminates at a top portion 130 thereof. To maintain positioning and promote free, unrestricted rotatable motion, the second end of the drive shaft is circumferentially fitted with a needle bearing 132 and thrust bearing 133 and collectively placed within an aperture 134 extending through the vertical brace. The primary plate gear, as shown in FIG. 7, is preferably mounted to an upper portion 136 of the first vertical shaft 122 while a lower portion 138 thereof comprises a secondary plate gear 140 in meshing arrangement with a tertiary plate gear 142 of a second gear drive 144. The tertiary gear plate, as illustrated in FIG. 8, is mounted to a second vertical shaft 146 like that used for the first gear drive 118 and is configured in such manner to mesh with a rack gear 148 that converts the rotational force of the first and second gear drives 118, 144 to a linear force to move back-and-forth the rack gear longitudinally within a midsection portion 150 of the drive housing 78. The resultant gear arrangement of the first and second gear drives along with that of the rack gear effectively function to reduce the output torque of the motor 14 to an acceptable value and re-orientate the output force of the motor for input into the piston drive assembly 88. Unlike the first vertical shaft, the second vertical shaft comprises top and bottom ends 146a, 146b extending above and below the drive housing a predetermined distance, with the top and bottom ends having a splined or hex-shaped configuration to fit and engage within an equally configured socket 60a integrally made part of an end 60b of the door swing arm 60. By including splined or hex shaped top and bottom ends, the door swing arm may be mounted or configured above or below the drive housing for varied mounting possibilities, respectively. As depicted in FIG. 7, the first and second vertical shafts 122, 146 are preferably journaled at opposite ends within needle bearings 152 and maintained longitudinally therein by means of thrust bearings 154. It is noted herein that the primary, secondary and tertiary plate gears and pinion gear of the drive transmission preferably comprise a helical cut configuration to promote noiseless meshing for quietness of operation of the door operator. It is further understood that any number of gear drives and/or plate gears may be incorporated in the electromechanical door operator 10 providing that the combination of gears effectively suffice to achieve a desirable gear reduction ratio for input into the piston drive assembly and properly orientate the direction of the rotational force for input into the rack gear 148 in such manner noted above.

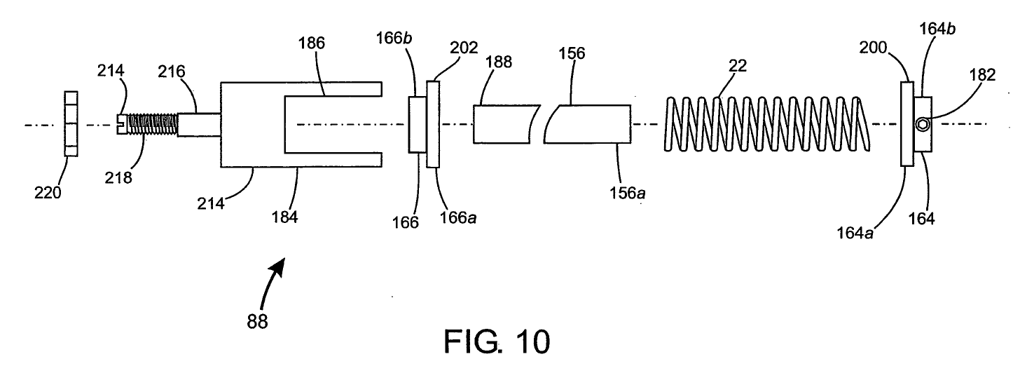

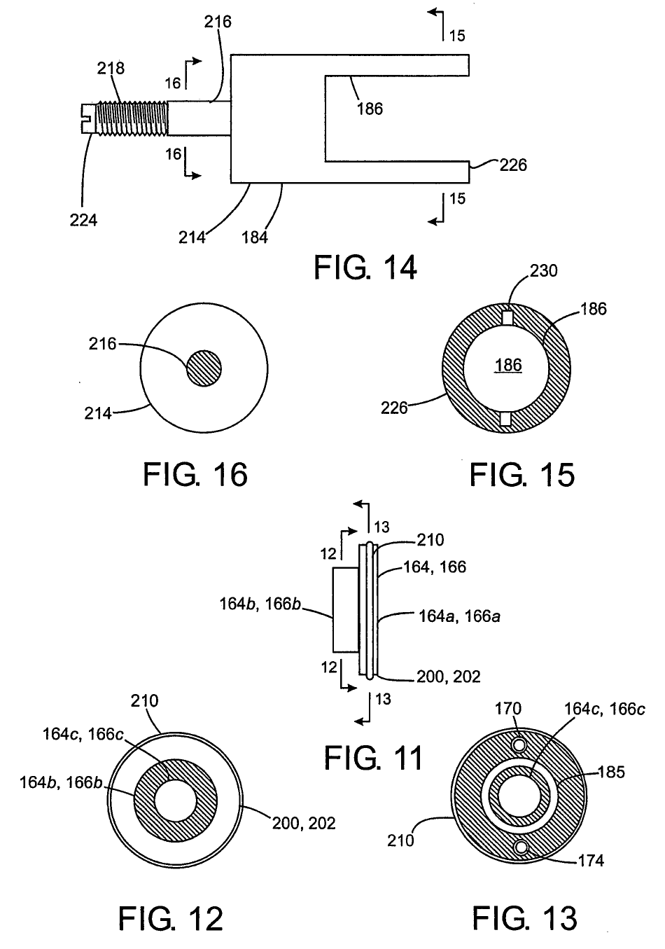

Referring now to FIGS. 7 and 8, the piston drive assembly 88 comprises in part a piston rod 156 extending lengthwise about the posterior portion of the drive housing 78 and having one end 156a passing through a support wall 158 located near the midsection portion of the drive housing for attachment to the rack gear 148 to correspond with the lateral movement thereof. An oil seal 160 circumferentially fitted about the piston rod and positioned within an aperture 162 extending through the support wall 158 serves to adequately contain hydraulic fluid and the like while the piston drive assembly cyclically operates in the posterior portion 76 of the drive housing. As shown is FIG. 10, the piston rod 156 is fitted with first and second spring backing plates 164, 166 that cooperate with one another to steady and hold the position of the spring 22 within the posterior portion of the drive housing. Each backing plate comprises primary and secondary cylindrical members 164a, 164b, 166a, 166b having a common aperture 164c, 166c extending centrally therethrough to accommodate the passage of the piston rod 156, while the secondary spring backing plate comprises a pair of diametrically opposed pressure relief ports 170 each having a tapered configuration and extending longitudinally through the primary cylindrical member to permit the passing of hydraulic fluid during cyclic operation. Fitted within each of the pressure relief ports is a ball 174 that upon its movement within the tapered configuration functions as a valve to permit one-way flow of the hydraulic fluid into or out of second and third chambers 178, 180. A pin 181 or equivalent is fitted into a larger diameter end 170a of the tapered configuration to prevent the ball from being released from the pressure relief port during operation. As illustrated in FIG. 10, the secondary cylindrical member 166b of the first spring backing plate most near the midsection portion 150 of the drive housing comprises a set screw 182 that locks in place the spring backing plate to the piston rod 156. The positioning of the first spring backing plate about the piston rod relative to the support wall 158 establishes the volumetric capacity of the first chamber 176, as can be seen in FIGS. 7 and 8, while the volumetric capacity of the second chamber is preferentially defined by the space in between the spring backing plates. A piston plunger 184 that is mounted onto the piston rod and located within the posterior portion of the drive housing 78 principally defines the second and third chambers 178, 180 for containment of hydraulic fluid for which is used in controlling the speed the spring 22 acts during door opening and closing operations. Each spring backing plate further comprises an annular recess 185 to receive and hold therein the opposite ends of the spring. The piston plunger comprises an interior cylindrical cavity 186 for housing therein a second end 188 of the piston rod and a pair of diametrically opposed conduits 190 for controlled passage of the hydraulic oil into the third chamber from the second, centermost chamber, as substantially illustrated in FIG. 7. The diametrically opposed conduits preferably extend lengthways about the piston plunger 184, each of which having one end 190a in alignment with the pressure relief ports of the second spring backing plate 166 and a second end 190b extending into the third chamber for hydraulic communication with the second chamber. Unlike the first spring backing plate, the second spring backing plate is configured in such manner to slidably move about the second end 188 of the piston rod to provide in part means for adjusting and controlling the tension of the spring 22 as will be discussed hereinafter in more descriptive detail. In addition to the conduits discussed above for passage of hydraulic fluid are two pairs of pathways 192, 194 existing interiorly within a wall of a sleeve 196 that uniformly lines each of the three chambers. As shown in FIGS. 7 and 8, the sleeve preferably extends the length of and lines an interior cylindrical surface 198 of the posterior portion of the drive housing and terminates at the support wall, wherein the resultant configuration permits an outer cylindrical surface 200, 202 of the first and second spring backing plates 164, 166 to engage and contact an inner surface 204 of the sleeve during static and cyclic operation of the piston drive assembly 88. The first pair of diametrically opposed pathways 192 serves as means for passing hydraulic fluid from the first chamber 176 to the second chamber 178, while the second set of diametrically opposed pathways 194 hydraulically connect the first chamber to the third chamber 180 as notably apparent when the spring 22 is in a compressive state. Fluid control through the diametrically opposed pathways is principally maintained by the first and second sets of backcheck valves 82, 84, particularly in the form of needle valves fitted into an equal number of threaded valve ports 206, 208 extending perpendicular through the sleeve's wall and drive housing, with the first and second sets of backcheck valves being dedicated for controlling the flow of hydraulic fluid through the first and second pairs of diametrically opposed pathways 192, 194, respectively. As shown in FIGS. 11-13, each of the outer cylindrical surfaces 200, 202 of the spring backing plates may be fitted with an o-ring 210 to enhance the seal in between the defined chambers discussed herein for sustained and predictable operating pressures. Fixedly attached to and extending outwardly from a rear portion 212 of a main cylindrical body 214 of the plunger assembly is a tensioning stem 216 that passes through the third chamber 180 and terminates exteriorly of the drive housing. A threaded portion 218 of the tensioner is fitted into and passes through a large diameter nut 220 that is mounted to a rearward end 222 of the drive housing. A slotted end 224 of the tensioner serves as means for increasing and decreasing the spring's tension within the posterior section of the drive housing 78. Clockwise rotation of the slotted end moves the piston plunger 184 in the direction of L₁, which increases the spring's tension for increased door closure speed and greater resistance during door opening operations for slower motion of door travel. Conversely, counterclockwise rotation of the slotted end 224 moves the piston plunger in the direction of L₂, which decreases the spring's tension for decreased door closure speed and less resistance during door opening operations for quicker motion of door travel. In both scenarios, however, the resultant speed is dictated in part by the adjustment of the backcheck valves 82, 84 that serve to regulate the flow of hydraulic fluid into and out of each of the first, second and third chambers 176, 178, 180 via the combined configuration of the diametrically opposed pathways and diametrically opposed pressure relief ports. To ensure that the diametrically opposed pressure relief ports of the second spring backing plate and diametrically opposed conduits of the piston plunger 184 maintain their aligned positioning during tensioning operations, particularly to maintain continued flow therethrough during operation, an annular wall member 226 of the piston plunger is attached to the secondary cylindrical member 166b of the second spring backing plate by means of a pin 228 fitted into a cavity 230, as depicted in FIGS. 14-15. As further illustrated in FIG. 7, the posterior portion of the drive housing comprises a fill port 232 extending into the third chamber and associated cap 234 for dispensing from time-to-time hydraulic fluid into each of the three chambers.

Referring to FIGS. 2 and 6, the drive housing 78 containing the mechanical components of the door operator 10, ECM 12, and motor 14 are collectively contained and housed within a case 236, which comprises means for mounting the assembly above the doorway 26 or header or upper portion thereof. To lessen the occurrence of vibration during operation of the door operator, rubber mounts 238 are situated in between a backside portion 240 of the case and structural member of the door header, as illustrated in FIG. 4. After mounting the case to the header, the first end 60a of the door swing arm is attached to the splined or hex-shaped top or bottom end of the second vertical shaft, which depends on the door swing configuration (configured for left- or right-handed operation). An opposite, second end 242 of the door swing arm comprises a roller 243 for fitment within an elongate opening 244 of a track 246 made mountable to an upper end 248 of the door. The roller serves as means for enabling the door swing arm to move freely about the track's length while the second vertical shaft rotates to permit door opening or closing operations. Other installations involve mounting the electronic strike assembly 18 to the doorjamb 30 and placing the pressure sensitive mat 52 interiorly within the door sweep area 54 of the floor's surface 34 and connecting each to ECM 12 via a peripheral device interface 250 for controlled activation and operation in such manner noted herein.

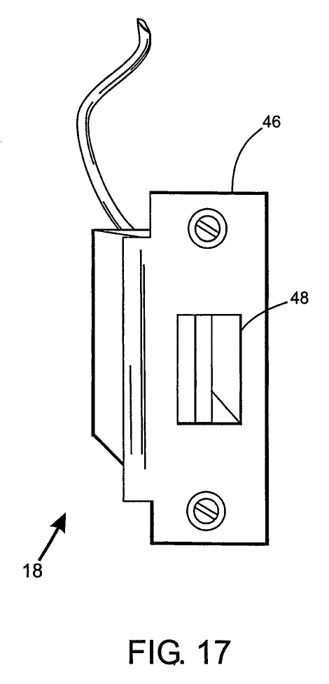

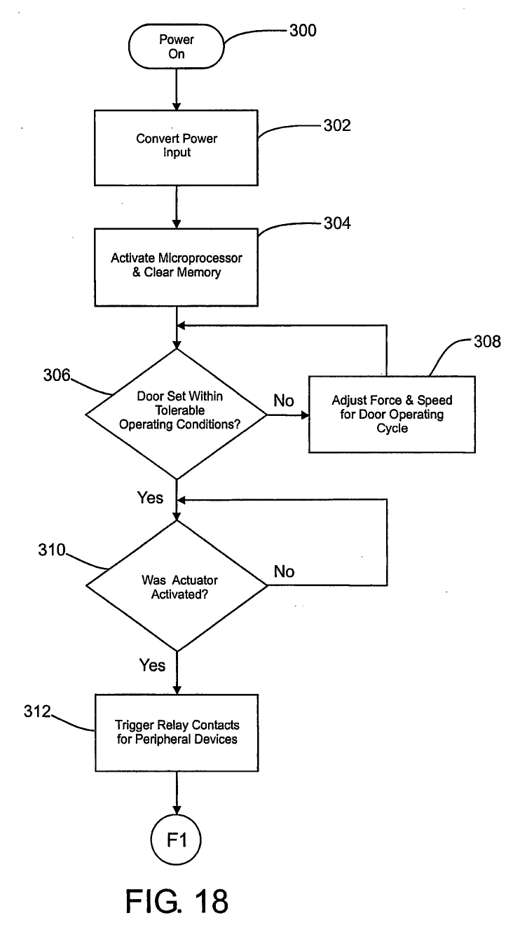

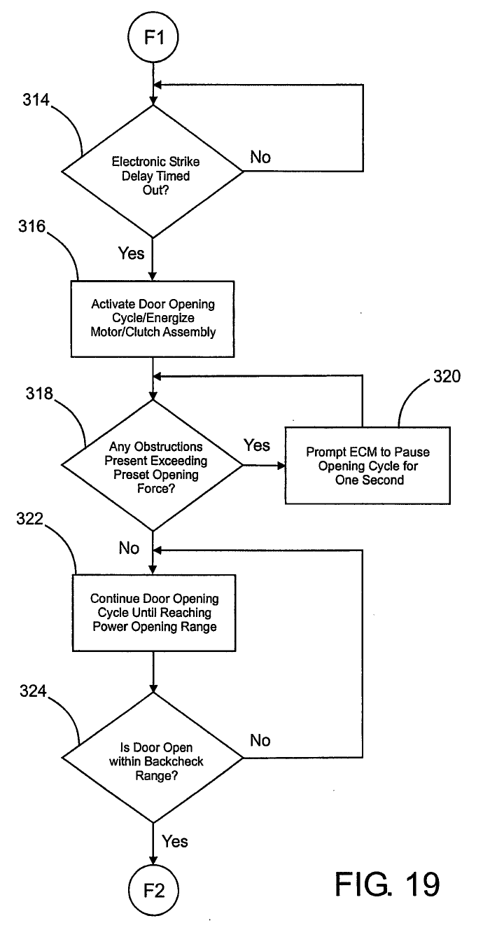

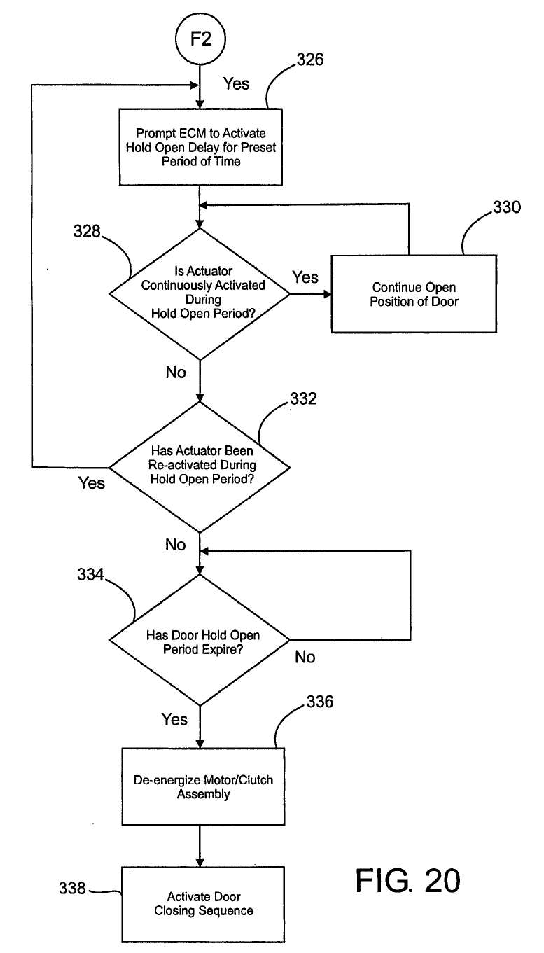

A motor-driven device for locking and unlocking the door may be used, as in the electronic strike assembly shown in FIG. 17. This assembly, is comprises a motor (not shown) operable for automated release of the outwardly extending plunger 44 from the plunger receptacle 48. One such electronic strike assembly is manufactured by the Securitron Magnalock Corporation of Sparks, Nev., specifically being marketed under the tradename UnLatch® Strike (UNL series). Suitable motor-driven strike assemblies are described in, e.g., U.S. Pat. No. 6,022,056 (see also U.S. Pat. No. 5,474,342) which are hereby incorporated herein by reference. Referring now to FIGS. 18-20, opening and closing operations of a door 28 mounted along the right edge portion 36 is discussed hereinafter. At step 300 in FIG. 18, 120 VAC power is initially supplied to ECM 12 by means of switching the three position selector mode switch 80 to “ON” followed at step 302 by rectification and stepping down the power input to 12 and 24 VDC for compatible power inputs into ECM-connected devices. At step 304, the microprocessor 66 is activated with simultaneous clearing of the random access memory (RAM) module. The resident member module 68, which comprises the programming instruction set, is not cleared at this step; only data inputs for operation of the door operator are cleared, which occurs upon reactivation of the power supply to the door operator if the door operator was disconnected from such supply after a predetermined period of time. At step 306, the user or operator is prompted for selector user inputs into ECM for storage into RAM and later execution by the microprocessor in accord with the commands set forth in the instruction set and manual adjustments at the door operator. At step 308, programmable inputs are performed via the external switches 71, wherein the user can selectively set such functions as opening speed (generally comprising a maximum opening speed to a 90° door position of 5 seconds) at SW1 and force (generally comprising a maximum force of 15 pounds) at SW2, the hold open time at SW3, notably the amount of time the door remains open after reaching the 90° position, and the 90° slow down time at SW4, notably the amount of time from a near open position of the door (at approximately 70°) to reaching the 90° position. Other programmable inputs include an electronic strike delay at SW5, which serves to delay the door opening cycle to accommodate the time for unlatching the outwardly extending plunger 44 from the plunger receptacle 48 of the electronic strike plate assembly. In all cases where adjustments are being made via the external switches, a LED mode indicator 252 is used to display and confirm the varied functional settings of SW1-SW5 for correct execution by the microprocessor. Further occurring at step 308, manual adjustments of the door operator are made via operation of the first and second sets of adjustable backcheck valves 82, 84, which function to regulate the flow of hydraulic fluid into and out of the three chambers for controlled operation of the door opening and closing cycles, particularly the speed the door opens and closes in conjunction with the spring's pretensioning state within the drive housing. At step 310, ECM determines whether the actuator 16 was activated by the presence of foot traffic on the pressure sensitive mat 52. If so, at step 312, relays (not shown) made part of the peripheral device interface are triggered to supply either 12 or 24 VDC power to the electronic strike assembly 18 for activation thereof for subsequent interactive communication with ECM. At step 314 in FIG. 19, ECM determines whether the preset time delay has lapsed to permit release of the outwardly extending plunger from the plunger receptacle before commencing the door opening cycle, as in accord with the setting made at SW5. After ECM times out the delay for release of the outwardly extending plunger from the strike plate assembly, at step 316, ECM energizes the motor 14 and clutch drive mechanism 96, if used in lieu of the coupling, whereupon its engagement causes the output shaft and drive shaft 108 to rotate in a counterclockwise direction, as denoted by path A₁ in FIG. 7. This counterclockwise motion of the drive shaft principally establishes the first gear drive to rotate in an equivalent counterclockwise manner, but perpendicularly thereabout, as denoted by path A₂, while the meshing interaction of the secondary plate gear with that of the tertiary plate gear causes clockwise movement of the second gear drive, as denoted by path A₃. The resultant movement of the gear drives serves to move the rack gear toward the left as denoted by path A₄ for pretensioning or establishing the requisite compression of the spring 22 contained within the second chamber of the drive housing and lateral movement of the piston plunger 184 toward the third chamber and rearward end of the drive housing. As this occurs, the second vertical shaft rotates in such manner to cause the door swing arm 60 to motion the door 28 outward to rotate about its pivot axis 32, while hydraulic fluid is permitted to flow one way toward the rearward end 222 of the drive housing through the diametrically opposed pressure relief ports 170 of the second spring backing plate and configurably aligned diametrically opposed conduits 190 of the piston plunger for collection into the third chamber 180. The spring's ability to compress quickly or slowly (backcheck) is maintained in part by the condition of the return flow of hydraulic fluid from the third chamber into the first chamber 176 via the second diametrically opposed pathways 194, which are principally regulated of flow by the backcheck valves 84. If in the event, at step 318, an obstruction or person is sensed within the door sweep area 54 during door opening operation, at step 320, ECM activates the obstruction detection circuit to pause the opening cycle for approximately one second. At step 322, if no obstruction is present within the door sweep area or it is removed, the door opening cycle continues until reaching the desired power opening range or backcheck range as programmed at ECM 12. After reaching the desired backcheck range at step 324, ECM is prompted in accord with the programmable setting to activate the hold open delay for a predetermined period of time at step 326 in FIG. 20. At step 328, ECM determines whether the actuator continues to be activated by the presence of foot traffic on the pressure sensitive mat, and if so, at step 330, the door's opened position is maintained by means of the motor's electronic braking mechanism 98 and associated circuitry coupled to ECM. At step 332, ECM determines whether the actuator was reactivated by means of foot traffic, and, if so, the door opening cycle restarts at step 326. At step 334, ECM determines whether the hold open time has expired, and if so, at step 336, ECM de-energizes the motor 14 and braking and clutch drive mechanisms. At step 338, ECM activates the door closing cycle, which commences by the release of the spring's stored potential energy, as initially established by the door opening cycle. During the door closing cycle, the piston plunger and rack gear move toward the right along path L₁ in FIG. 8, while the second and first gear drives rotate counterclockwise and clockwise, respectively, to move accordingly and inwardly toward the door's header the return of the door swing arm 60 and return positioning of the door 28 against the doorstop 38. As this occurs, hydraulic fluid that had been accumulated in the first chamber 180 during the opening cycle is permitted to flow toward and into the second chamber 178 via the first pair of diametrically opposed pathways 192 positioned within the sleeve's wall structure, while flow is primarily restricted into the second chamber from the first chamber by means of the first set of adjustable backcheck valves 82. This configuration and operation of the hydraulic flow through the aforementioned chambers and pathways establishes in part the speed for which the door closes and latches.

From the foregoing, it will be apparent that embodiments of automated door apparatuses herein include those that automatically operate to open and close a restroom door through activation of the pressure sensitive mat suitably positioned within the door sweep area or near the door. Such mats may be limited to placement only within the interior of a restroom, e.g., as in a privacy restroom. Alternatively, other foot-actuatable or other hands-free actuators may be used. The opening and closing of the door is primarily accomplished by mechanical means under microprocessor control, whereby provisions are made to permit the door to open automatically or manually if in the event of a power failure or if so desired, preferably being capable of operating at or near an opening force of at least five pounds. Moreover, one's privacy while in the restroom is maintained by the combined utilization and functionality of the electronic strike assembly 18 and push-button locking mechanism 50. The opening and closing of the door is maintained smooth and quiet for unobtrusive operation, with hold open provisions being made for safety if in the event an obstruction is sensed within the door sweep area 54 or an object continues to rest upon the pressure sensitive mat 52.

While there has been shown and described particular embodiments of the invention, various changes and alterations can be made therein without departing from the scope and spirit of the invention. In general, the features of the various embodiments may be mixed-and-matched with each other in new combinations as guided by the need to make an operable device.

It is claimed:

1. An automated exit apparatus for a lockable privacy restroom comprising:
a door operator, an electronically activatable motorized strike system, and a door actuator operable without physical contact by a user's hand that is mounted on an interior of a privacy restroom, the actuator being user-actuatable to unlock the door by electronically activating the motor for the strike and to open the door by electronically activating the operator.

2. The entry apparatus of claim 1 wherein the door actuator is located on or near a floor of the restroom for user activation by pressing with a foot on the door actuator.

3. The entry apparatus of claim 1 wherein the door actuator is a touchless sensor.

4. The entry apparatus of claim 1 wherein the door operator is a low-energy operator.

5. The apparatus of claim 4 wherein the low-energy operator comprises a motor that engages a swing arm to open the door, and further comprises a clutch disposed between the motor and the swing arm that is disengaged unless the actuator is actuated such that the door can be opened manually by the user without engaging the motor.

6. The apparatus of claim 1 wherein the door is manually operable for entry and for exit within ADA guidelines.

7. The apparatus of claim 1 wherein the automated exit apparatus automates exit but not entry of the restroom.

8. A method of automating a privacy restroom, the method comprising placing an actuator operable without physical contact by a user's hand in an interior of the privacy restroom that is actuatable to unlock and open the restroom door.

9. The method of claim 8 comprising mounting the actuator on or near a floor of the restroom for user activation by pressing a foot on the door actuator.

10. The method of claim 8 wherein the actuator is a touchless sensor.

11. The method of claim 8 further comprising mounting a low-energy operator that opens the door in response to the actuation and installing a motorized strike that moves to unlock the door in response to the actuation.

12. The method of claim 11 wherein the low-energy operator comprises a motor that engages a swing arm to open the door, and further comprises a clutch disposed between the motor and the swing arm that is disengaged unless the actuator is actuated such that the door can be opened manually by the user without engaging the motor.

13. The method of claim 8 wherein the door is manually operable for entry and for exit within ADA guidelines.

14. The method of claim 8 wherein the automated exit apparatus automates exit but not entry of the restroom.
